(19) United States
(12) Patent Application Publication
(10) Pub. No.: US 2008/0143426 A1
(43) Pub. Date: Jun. 19, 2008

(54) Method for reducing leakage current of thin film transistor by applying static voltage

(75) Inventor: Shuo-Ting Yan, Miao-Li (TW)

Correspondence Address: WEI TE CHUNG;FOXCONN INTERNATIONAL, INC., 1650 MEMOREX DRIVE, SANTA CLARA, CA, 95050, US

(73) Assignee: INNOLUX DISPLAY CORP.

(21) Appl. No.: 12/002,347

(22) Filed: Dec. 17, 2007

(30) Foreign Application Priority Data
Dec. 15, 2006 (TW) 95147248

(51) Int. Cl. G05F 1/10

(52) U.S. Cl. 327/538

(57) ABSTRACT

An exemplary method for reducing leakage current of thin film transistors (TFTs) of a TFT array substrate (200) includes: providing a TFT array substrate, the TFT array substrate including a number of gate lines, a number of data lines, and a number of TFTs, each TFT including a gate electrode, a source electrode and a drain electrode, the gate electrodes being connecting to the gate lines, the source electrodes being connecting to the data lines; providing a same direct current voltage to the source electrodes and the drain electrodes; and providing another direct current voltage to the gate electrodes to turn off the TFTs, and continuing to provide said same direct current voltage to the source electrodes for a predetermined time.

### CROSS-REFERENCE TO RELATED APPLICATIONS

This application claims all benefits accruing under 35 U.S.C. §119 from Taiwan Patent Application No. 95147248, filed on 2006/12/15 in the Taiwan Intellectual Property Office, the disclosure of which is incorporated herein by reference.

### FIELD OF THE INVENTION

The present invention relates to methods for reducing leakage current of thin film transistors (TFTs) of a TFT array substrate of a liquid crystal display (LCD), and particularly to a method for reducing leakage current of TFTs by applying static bias voltages to the TFTs.

### GENERAL BACKGROUND

A typical liquid crystal display (LCD) is capable of displaying a clear and sharp image through thousands or even millions of pixels that make up the complete image. The LCD has thus been applied to various electronic equipment in which messages or pictures need to be displayed, such as mobile phones and notebook computers. A liquid crystal panel is a major component of the LCD, and generally includes a thin film transistor (TFT) array substrate, a color filter substrate parallel to the TFT array substrate, and a liquid crystal layer sandwiched between the two substrates. The TFT array substrate includes a plurality of TFTs, which function as switching elements.

Referring to FIG. 6, part of a typical TFT array substrate 100 is shown. The TFT array substrate 100 includes a substrate 110, and a multiplicity of TFTs 150 formed on the substrate 110. Each TFT 150 is a P-type LTPS (low temperature poly-silicon) TFT, and includes a semiconductor layer 151, an insulating layer 152, and a gate electrode 153. The semiconductor layer 151 is formed on the substrate 110, and includes a source portion 154, a drain portion 155 and a channel portion 156. The source portion 154 and the drain portion 155 are located at two opposite sides of the channel portion 156 respectively. The source portion 154 and the drain portion 155 are doped with impurities, and serve as a source electrode and a drain electrode respectively. The source portion 154 and the drain portion 155 are connected by the channel portion 156, thus forming two junctions (not labeled). The insulating layer 152 is formed on the semiconductor layer 151. The gate electrode 153 is formed on the insulating layer 152, in a position corresponding to the channel portion 156.

When the TFT 150 works, a negative voltage is applied between the gate electrode 153 and the source portion 154. A strong electric field is generated in the insulating layer 152, and the electric field repulses electrons and attracts holes in the channel portion 156 adjacent to the insulating layer 152. Thereby, a conductive channel is generated in the channel portion 156. Thus, the source portion 154 and the drain portion 155 are connected via the conductive channel, so that the TFT 150 is turned on. On the contrary, when a positive voltage is applied between the gate electrode 153 and the source portion 154, the TFT 150 is turned off.

During a process of manufacturing the TFTs 150, some defects may be generated. The defects are particularly liable to occur at or near the junction between the drain portion 155 and the channel portion 156 of a TFT 150, and at or near the junction between the source portion 154 and the channel portion 156 of a TFT 150. Such defects include disordered atoms and broken bonds. Thus, when the TFT 150 is turned off, a leakage current is liable to occur. As a result, the TFT array substrate 100 has impaired performance.

What is needed, therefore, is a method for reducing leakage current of TFTs of a TFT array substrate that can overcome the above-described problems.

### SUMMARY

In one preferred embodiment, a method for reducing leakage current of TFTs of a TFT array substrate includes: providing a TFT array substrate, the TFT array substrate including a plurality of gate lines, a plurality of data lines, and a plurality of TFTs, each TFT including a gate electrode, a source electrode and a drain electrode, the gate electrodes being connecting to the gate lines, the source electrodes being connecting to the data lines; providing a same direct current voltage to the source electrodes and the drain electrodes; and providing another direct current voltage to the gate electrodes to turn off the TFTs, and continuing to provide said same direct current voltage to the source electrodes for a predetermined time.

Other novel features and advantages will become more apparent from the following detailed description when taken in conjunction with the accompanying drawings.

### BRIEF DESCRIPTION OF THE DRAWINGS

FIG. 1 is a flowchart summarizing a method for reducing leakage current of TFTs of a TFT array substrate according to a first embodiment of the present invention, wherein two power supply sources provide voltages to the TFT array substrate.

FIG. 2 is essentially an abbreviated circuit diagram of a typical TFT array substrate used in the method of FIG. 1.

FIG. 3 is an abbreviated circuit diagram of the power supply sources used in the method of FIG. 1.

FIG. 4 is similar to FIG. 2, but showing the power supply sources of FIG. 3 connected to the TFT array substrate.

FIG. 5 is a flowchart summarizing a method for reducing leakage current of TFTs of a TFT array substrate according to a second embodiment of the present invention.

FIG. 6 is a schematic, side, cross-sectional view of part of a conventional TFT array substrate.

### DETAILED DESCRIPTION OF PREFERRED EMBODIMENTS

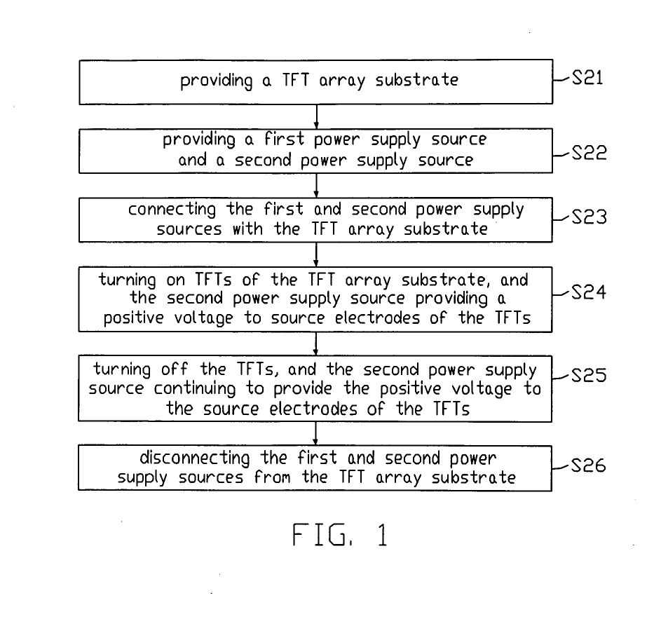

Referring to FIG. 1, a flowchart summarizing a method for reducing leakage current of thin film transistors (TFTs) of a TFT array substrate according to a first embodiment of the present invention is shown. The method includes: step S21, providing a TFT array substrate; step S22, providing a first power supply source and a second power supply source; step S23, connecting the first and second power supply sources with the TFT array substrate; step S24, turning on TFTs of the TFT array substrate, and the second power supply source providing a positive voltage to source electrodes of the TFTs; step S25, turning off the TFTs, and the second power supply source continuing to provide the positive voltage to the source electrodes of the TFTs; and step S26, disconnecting the first and second power supply sources from the TFT array substrate.

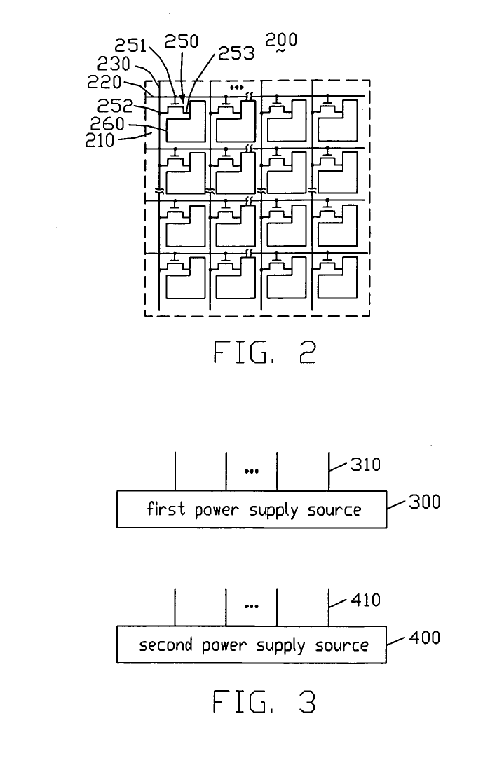

Referring to FIG. 2, in step S21, a TFT array substrate 200 is provided. The TFT array substrate 200 includes a substrate 210, a plurality of gate lines 220 parallel to each other, a plurality of data lines 230 parallel to each other and perpendicular to the gate lines 220, a plurality of TFTs 250 arranged at intersections of the data lines 230 and gate lines 220 respectively, and a plurality of pixel electrodes 260. The TFTs 250 are typically P-type TFTs, and even more typically P-type LTPS (low temperature poly-silicon) TFTs. Each of the TFTs 250 includes a gate electrode 251, a source electrode 252, and a drain electrode 253. The source electrode 252 and the drain electrode 253 are formed by doping a semiconductor with impurities. The gate electrode 251 is connected to a corresponding gate line 220, the source electrode 252 is connected to a corresponding data line 230, and the drain electrode 253 is connected to a corresponding pixel electrode 260.

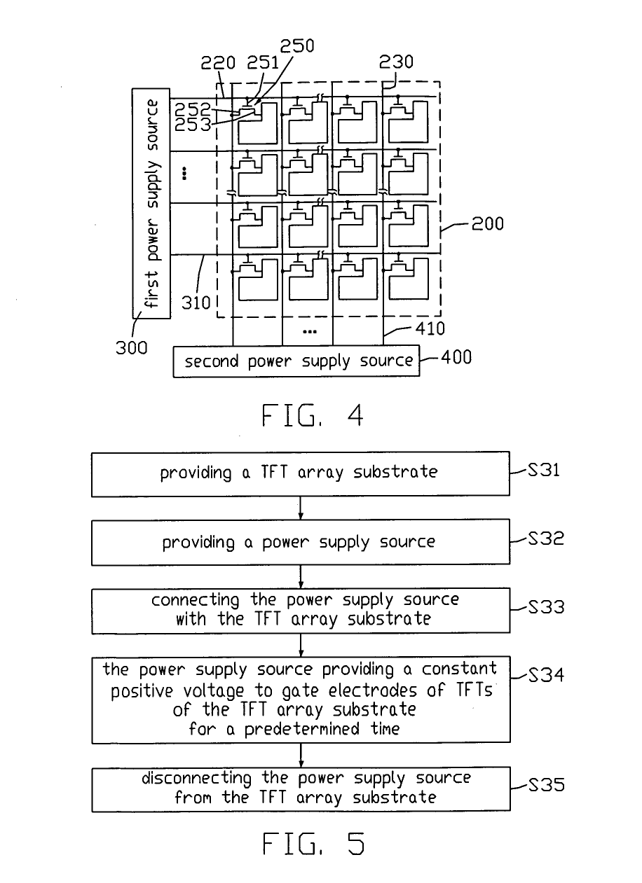

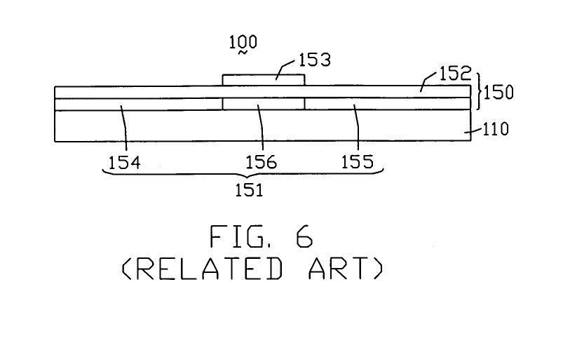

Referring to FIG. 3, in step S22, a first power supply source 300 and a second power supply source 400 are provided. The first power supply source 300 includes a plurality of first output lines 310. The number of first output lines 310 is equal to the number of gate lines 220 of the TFT array substrate 200. The second power supply source 400 includes a plurality of second output lines 410. The number of second output lines 410 is equal to the number of data lines 230 of the TFT array substrate 200.

Referring to FIG. 4, in step S23, the first output lines 310 are connected to the gate lines 220 respectively. The second output lines 410 are connected to the data lines 230 respectively.

In step S24, the first power supply source 300 provides a first direct current voltage such as −20 volts to the gate electrodes 251 of the TFTs 250 via the gate lines 220 so as to turn on the plurality of TFTs 250. At the same time, the second power supply source 400 provides a second direct current voltage such as 10 volts to the source electrodes 252 of the TFTs 250 via the data lines 230. Because the TFTs 250 are turned on, the 10 volt direct current voltage is also applied to the drain electrodes 253 of the TFTs 250.

In step S25, the first power supply source 300 provides a third direct current voltage to the gate electrodes 251 of the TFTs 250 via the gate lines 220 so as to turn off the TFTs 250. The third direct current voltage can be 20 volts. When the TFTs 250 are turned off, the second power supply source 400 continues to output the 10 volt direct current voltage to the source electrodes 252 of the TFTs 250 for at least 120 seconds. In one example, such output is for 3600 seconds. This process is defined as a static bias voltage process. In this static bias voltage process time interval, no current flows occur between the source electrodes 252 and the drain electrodes 253 because the source electrodes 252 and the drain electrodes 253 have the same potential.

In step S26, the first power supply source 300 and the second power supply source 400 are disconnected from the TFT array substrate 200.

Because a static bias voltage process is conducted on the TFT array substrate 200, a static electric field is generated in the channel portion of each TFT 250. In particular, a constant (static) junction electric field is generated at the junction between the channel portion and the source electrode 252, and between the channel portion and the drain electrode 253. Some defects are transferred away from these junctions, and other defects are rectified (e.g. broken bonds are repaired). That is, the defects are reduced by the static junction electric field. This results in a low leakage current at these junctions during use of the TFT array substrate 200 thereafter. Therefore, the performance of the TFT array substrate 200 is improved.

Referring to FIG. 5, a flowchart summarizing a method for reducing leakage current of TFTs of a liquid crystal panel according to a second embodiment of the present invention is shown. The method includes: step S31, providing a TFT, array substrate; step S32, providing a power supply source; step S33, connecting the power supply source with the TFT array substrate; step S34, the power supply source providing a constant positive voltage to gate electrodes of TFTs of the TFT array substrate for a predetermined time; and step S35, disconnecting the power supply source from the TFT array substrate. In step S34, the positive voltage applied to the gate electrodes is maintained for at least 120 seconds, and preferably 3600 seconds. The positive voltage applied to the gate electrodes is typically 20 volts.

Further and/or alternative embodiments may include the following. In step S25 of the first embodiment, the third direct current voltage applied to the gate electrodes 251 by the first power supply source 300 can be 0 volts. Furthermore, if the TFTs 250 are N-type LTPS TFTs, all the voltages applied to the TFTs 250 are the reverse polarity of the above-described voltages.

It is believed that the present embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments of the invention.

What is claimed is:

1. A method for reducing leakage current of thin film transistors (TFTs) of a TFT array substrate, the method comprising:
providing a TFT array substrate, the TFT array substrate comprising a plurality of gate lines, a plurality of data lines, and a plurality of TFTs, each TFT comprising a gate electrode, a source electrode, and a drain electrode, the gate electrodes being connecting to corresponding gate lines, the source electrodes being connecting to corresponding data lines;
providing a same direct current voltage to the source electrodes and the drain electrodes; and
providing another direct current voltage to the gate electrodes to turn off the TFTs, and continuing to provide said same direct current voltage to the source electrodes for a predetermined time.

2. The method as claimed in claim 1, wherein providing said same direct current voltage and providing said another direct current voltage comprises:
providing a first direct current voltage to the gate electrodes via the gate lines to turn on the TFTs;
providing said same direct current voltage to the source electrodes and the drain electrodes via the data lines and the source electrodes; and
providing said another direct current voltage to the gate electrodes via the gate lines to turn off the TFTs.

3. The method as claimed in claim 2, wherein the predetermined time is at least 120 seconds.

4. The method as claimed in claim 3, wherein the predetermined time is at least 3600 seconds.

5. The method as claimed in claim 2, wherein the TFTs are P-type TFTs.

6. The method as claimed in claim 5, wherein the first direct current voltage is a negative 20 volt voltage, said same direct current voltage is a positive 10 volt voltage, and said another direct current voltage is a positive 20 volt voltage.

7. The method as claimed in claim 5, wherein the first direct current voltage is a negative 20 volt voltage, said same direct current voltage is a positive 10 volt voltage, and said another direct current voltage is a zero volt voltage.

8. The method as claimed in claim 6, wherein a first power supply source provides the first and said another direct current voltages, and a second power supply source provides said same direct current voltage.

9. The method as claimed in claim 8, wherein the first power supply source comprises a plurality of first output lines, the second power supply source comprises a plurality of second output lines, the number of first output lines is equal to the number of gate lines, and the number of second output lines is equal to the number of data lines.

10. The method as claimed in claim 1, wherein the TFTs are N-type low temperature poly-silicon TFTs.

11. The method as claimed in claim 10, wherein the first direct current voltage is a positive 20 volt voltage, said same direct current voltage is a negative 10 volt voltage, and said another direct current voltage is a negative 20 volt voltage.

12. A method for reducing leakage current of thin film transistors (TFTs) of a TFT array substrate, the method comprising:
providing a TFT array substrate, the TFT array substrate comprising a plurality of gate lines, and a plurality of TFTs, each TFT comprising a gate electrode, a source electrode, and a drain electrode, the gate electrodes being connecting to corresponding gate lines; and
providing a direct current voltage to the gate electrodes via the gate lines for a predetermined time.

13. The method as claimed in claim 12, wherein the predetermined time is at least 120 seconds.

14. The method as claimed in claim 13, wherein the predetermined time is 3600 seconds.

15. The method as claimed in claim 12, wherein the direct current voltage is a positive 20 volt voltage.

16. A method for reducing leakage current of thin film transistors (TFTs) of a TFT array substrate, the method comprising:
providing a TFT array substrate, the TFT array substrate comprising a plurality of gate lines, a plurality of data lines, and a plurality of TFTs, each TFT comprising a gate electrode, a source electrode, and a drain electrode, the gate electrodes being connecting to corresponding gate lines, the source electrodes being connecting to corresponding data lines; and
applying a static direct current voltage process to the TFT array substrate for a predetermined time, comprising:
providing a first direct current voltage to the gate electrodes via the gate lines to turn on the TFTs;
providing a second direct current voltage to the source electrodes and the drain electrodes via the data lines and the source electrodes; and
providing a third direct current voltage to the gate electrodes via the gate lines to turn off the TFTs, and continuing to provide said same second direct current voltage to the source electrodes for the predetermined time.

17. The method as claimed in claim 18, wherein the predetermined time is at least 120 seconds.

18. The method as claimed in claim 18, wherein the predetermined time is at least 3600 seconds.
